(19) United States
(12) Patent Application Publication
(10) Pub. No.: US 2017/0215474 A1
(43) Pub. Date: Aug. 3, 2017

(54) ANNULAR STEREOSCOPIC-HEATING ELECTRONIC CIGARETTE WITH REPLACEABLE INNER CONTAINER

(71) Applicant: Lrider Technology Co.,Ltd, Shenzhen (CN)

(72) Inventor: Yongsheng LI, Shenzhen (CN)

(73) Assignee: Lrider Technology Co.,Ltd, Shenzhen (CN)

(21) Appl. No.: 15/012,854

(22) Filed: Feb. 2, 2016

(51) Int. Cl. A24F 47/00; H05B 3/12; A24F 7/04

(52) U.S. Cl. CPC A24F 47/008; A24F 7/04; H05B 3/12; G05B 2219/37428

(57) ABSTRACT

This invention provides an annular stereoscopic-heating electronic cigarette with replaceable inner container, comprising: a cylindrical electronic cigarette body; the electronic cigarette body comprises a smoke-filtering member, an annual stereoscopic-heating member and a heat-controlling member; wherein: the annual stereoscopic-heating member comprises an annual stereoscopic-heating casing, and an openwork member for conducting heat. A nickel cadmium (Ni-Cd) heating coil is spirally wind around and firmly contacts the exterior surface of the open member. A replaceable shredded tobacco inner container is sleeved within the openwork member. The exterior of the Ni-Cd heating coil and the bottom of the openwork member are respectively wrapped around by an asbestos heat-insulating layer. A short-circuit contactor is set at the bottom of the annular stereoscopic-heating casing and connects to the Ni-Cd beating coil.

### TECHNICAL FIELD

This invention relates to the technical field of electronic cigarettes, in particular, relates to an annular stereoscopic-heating electronic cigarette with replaceable inner container.

### BACKGROUND

It has been more than 300 years since tobacco was introduced into the Chinese market in 18th century. As time goes by, various smoking sets emerge in an endless stream, and each of them has its own functions. Taking electronic cigarette as an example, when using the smoking set in the current market, the tobacco needs to be processed into shredded tobacco, which is complicated and costs a lot. It is also prone to cause waste, while adding the shredded tobacco into the smoking set. Naked flame is required to light the shredded tobacco, which would create harmful tar, and more than 460 chemical substances, which would cause diseases relating to the respiratory system and the cardiovascular system, carcinogen, create “second hand smoke”, and would also pollute the environment. Moreover, the homogeneous products are usually heated by the Nickel-Cadmium alloy filament, which cannot provide evenly heat and cause excessive local temperature. As a result, the shredded tobacco is prone to be charred and taste bad. Furthermore, it is not convenient to deal with the tobacco ash left bye the burned tobacco, and while smoking the excessive high temperature of the smoke taken into the mouth would easily scald the mouth. The insufficient burning of the cigarette would produce harmful smoke. Therefore, there are lots of improvements required to be made on the electronic smoking set.

### SUMMARY OF THE INVENTION

In order to overcome the above disadvantages existing in the current technology, the subject of this invention is to provide an annular stereoscopic-heating electronic cigarette with replaceable inner container, which uses a PCBA to control the smoking temperature and heating time, and wherein the inner container for placing shredded tobacco is easy to be replaced and cleaned, and the electronic cigarette uses spiral integrated-beating which can provide heat evenly and rapidly.

The technology provided in this invention for solving the mentioned problems is as follows:

an annular stereoscopic-heating electronic cigarette with replaceable inner container, comprising a cylindrical electronic cigarette body; wherein the electronic cigarette body comprises a smoke-filtering member, an annual stereoscopic-heating member and a beat-controlling member; wherein: the annual stereoscopic-heating member comprises an annual stereoscopic-heating casing, and an openwork member for conducting heat. A nickel cadmium (Ni-Cd) heating coil is spirally wind around and firmly contact to the exterior surface of the openwork member. A replaceable shredded tobacco inner container is sleeved within the openwork member. The exterior of the Ni-Cd heating coil and the bottom of the openwork member are respectively wrapped around by an asbestos heat-insulating layer. A short-circuit contactor is set at the bottom of the annular stereoscopic-heating casing and connects to the Ni-Cd heating coil.

As a further improvement of this invention, the smoke-filtering member and the heat-controlling member are connected to the two ends of the annular stereoscopic heating member by threaded connection. The smoke-filtering member comprises a cigarette holder, wherein the cigarette holder is sleeved on a cigarette holder union joint, a filter piece is set on the bottom of the cigarette holder, a cigarette holder protecting cover is set on the upper part of the cigarette holder union joint, and the lower part of the cigarette holder union joint connects to the annular stereoscopic-heating member.

As a further improvement of this invention, the heat-controlling member comprises a heat-controlling casing and a power source within the heat-controlling casing. A Universal Serial Bus (USB) charging interface is set at the bottom of the heat-controlling casing. A matching battery short-circuit contactor, which is connected to the short-circuit contactor, is set on the upper part of the heat-controlling casing. A Printed Circuit Board. Assembly (PCBA) controlling board and a plurality of controlling buttons corresponding to the PCBA controlling board are set on the upper part of the power source.

As a further improvement of this invention, the openwork member is a hollowed cylinder with a plurality of holes set on its circumferential surface, or the openwork member is an inner container supporter assembled by a plurality of brackets; wherein the hollowed cylinder or the inner container supporter is made of aluminum.

As a further improvement of this invention, the shape of the smoke-controlling button is a triangle. A plurality of bumps, which can be a protection and are comfortable to use, are evenly set on the surface of the smoke-controlling button. A plurality of recesses, which can be a protection and are comfortable to use, are set on the surface of the annular stereoscopic-heating casing and heat-controlling casing.

Compared to the existing technology this invention has the advantages as follows: in this invention, the nickel cadmium (Ni-Cd) heating coil is spirally wind around and directly contacts the openwork member or the hollowed cylinder, so that the whole of the openwork member or the hollowed cylinder can produce heat to act on the shredded tobacco inner container. As a result, the shredded tobacco within the shredded tobacco;inner container can be evenly heated, and it can be avoided from the situations that some of the shredded tobacco has not been burned whereas some other shredded tobacco is charred and produces high-temperature and harmful smoke which would scald the mouth. At the same time, the PCBA controlling board accurately controls the baking and burning temperature and heating time of the shredded tobacco inner container. This way, the shredded tobacco inner container can rapidly heat up and completely burn the shredded tobacco, which results to avoid the harmful substance produced during the heating process of the shredded tobacco and hemp plants, thus prolonging the smoking time. Because of the replaceable shredded tobacco inner container, the shredded tobacco inner container can be drawn out and the shredded tobacco can directly be put in, avoiding the waste of shredded tobacco. This will make it more convenient to be cleaned and easy to remove the harmful remanent tobacco tar, further avoiding the production of the harmful smoke. Meanwhile, the appearance of this invention is small and exquisite, and a plurality of antiskid bumps and recesses, which are designed according to the human body engineering, are set on the exterior of the casing, which makes it convenient for the user to smoke and carry.

### BRIEF DESCRIPTION OF THE DRAWING

FIG. 1 is a schematic diagram of this invention.

FIG. 2 is an enlarged partial view of A.

FIG. 3 is another schematic diagram of this invention.

### DETAILED DESCRIPTION OF THE INVENTION

This invention will be further described in conjunction with the figures and the following embodiments:

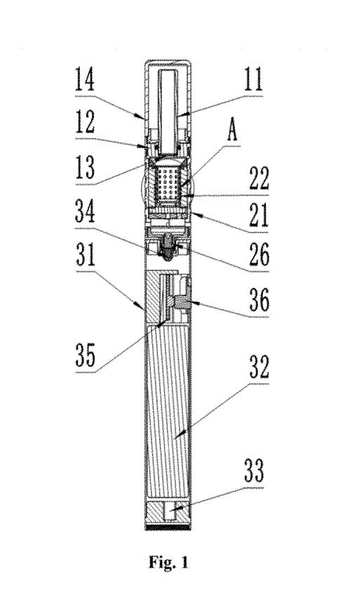

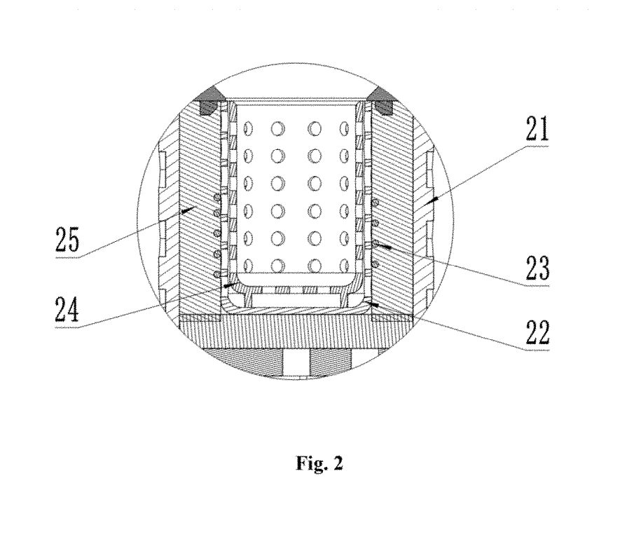

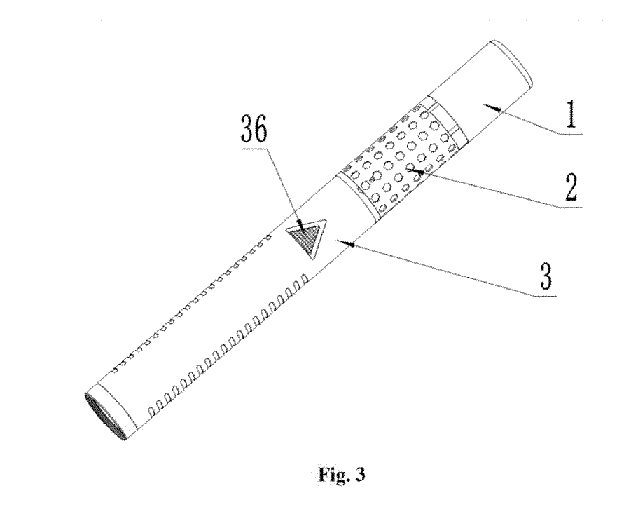

Referring to FIG. 1, FIG. 2 and FIG. 3, an annular stereoscopic-heating electronic cigarette with a replaceable inner container, comprises: a cylindrical electronic cigarette body; wherein the electronic cigarette body comprises smoke-filtering member 1, annual stereoscopic-heating member 2 and heat-controlling member 3; wherein: annual stereoscopic-beating member 2 comprises annual stereoscopic-heating casing 21, and openwork member 22 for conducting heat. Nickel cadmium (Ni-Cd) heating coil 23 is spirally wind around and firmly contacts to the exterior surface of openwork member 22, replaceable shredded tobacco inner container 24 is sleeved within openwork member 22 the exterior of Ni-Cd heating coil 23 and the bottom of openwork member 22 are respectively wrapped around by asbestos heat-insulating layer 25; short-circuit contactor 26 is set: on the bottom of annular stereoscopic-heating casing, 21 and connects to Ni-Cd heating coil 23.

Openwork member 22 in this invention is an aluminum hollowed cylinder with a plurality of holes set on its circumferential surface. While smoking, heat produced by Ni-Cd heating coil 23 will be passed onto aluminum hollowed cylinder, expanding the heating area from line to plane. At the same time, the produced heat can rapidly flow around through the plurality of holes on the circumferential surface. As a result, a stereoscopic-heating condition is formed and acts on the shredded tobacco inner container, so that the shredded tobacco is heated rapidly and evenly.

Smoke-filtering member 1 and heat-controlling member 3 are respectively connected to the two ends of annular stereoscopic heating member 2 by threaded connection. Smoke-filtering member 1 comprises cigarette holder 11, wherein: cigarette holder 11 is sleeved on cigarette holder union joint 12, filter piece 13 is set on the bottom of cigarette holder 11, cigarette holder protecting cover 14 is set on the upper part of cigarette holder union joint 12, and the lower part of cigarette holder union joint 12 connects to annular stereoscopic-heating member 2.

By the threaded connection, smoke-filtering member 1 can firmly connect to heat-controlling member 3, and the connection provides a better sealing. At the same time, it is easy to draw out the shredded tobacco inner container and put the shredded tobacco in, which provides convenience for cleaning the tobacco tar and consequently reduces to production of harmful smoke.

Heat-controlling member 3 comprises heat-controlling casing 31 and power source 32 within heat-controlling casing 31. Universal Serial Bus (USB) interface 33 is set on the bottom of heat-controlling casing 31, Battery short-circuit contactor 34, which is matching with short-circuit contactor 26, is set on the upper part of heat-controlling casing 31. Printed Circuit Board Assembly (PCBA) controlling board 35 and plurality of controlling buttons 36 corresponding to PCBA controlling board 35 are set on the upper part of power source 32.

The adoption of USB interface 33 is convenient for charging. By accurately controlling the baking and burning temperature and heating time for the shredded tobacco via PCBA controlling board 35, the shredded tobacco cart get a more complete burning, and double the smoking time than the normal cigarette, and further reduce the production of harmful smoke.

The shape of smoke-controlling button 36 is a triangle. A plurality of bumps, which can be a protection and are designed according to human engineering, are evenly set on the surface of smoke-controlling button 36. A plurality of recesses, which can be a protection and are designed according to human engineering, are set on the surface of annular stereoscopic-heating casing 21 and heat-controlling casing 31.

This invention is designed according to human engineering, and the appearance is small and exquisite. It is convenient to be clamped by fingers and also convenient for the user to smoke and carry.

As described above, any corresponding modification made by one of ordinary skill in the art without creative effort should be considered as falling within the protection scope of this invention.

What is claimed are:

1. An annular stereoscopic-heating electronic cigarette with replaceable inner container, comprising:
a cylindrical electronic cigarette body; wherein the electronic cigarette body comprises a smoke-filtering member, an annual stereoscopic-heating member and a heat-controlling member;
wherein: the annual stereoscopic-heating member comprises an annual stereoscopic-heating casing, and an openwork member for conducting heat; a nickel cadmium (Ni-Cd) heating coil is spirally wind around and firmly contacts to the exterior surface of the openwork member; a replaceable shredded tobacco inner container is sleeved within the openwork member; the exterior of the Ni-Cd heating coil and the bottom of the openwork member are respectively wrapped around by an asbestos heat-insulating layer; a short-circuit contactor is set on the bottom of the annular stereoscopic-heating casing and connects to the Ni-Cd heating coil.

2. The annular stereoscopic-heating electronic cigarette according to claim 1, wherein, the smoke-filtering, member and the heat-controlling member are respectively connected to each end of the annular stereoscopic heating member by threaded connection;
the smoke-filtering member comprises a cigarette holder, wherein: the cigarette holder is sleeved on a cigarette holder union joint; a filter piece is set at the bottom of the cigarette holder; a cigarette holder protecting cover is set at the upper part of the cigarette holder union joint, the lower part of the cigarette holder union joint connects to the annular stereoscopic-heating member.

3. The annular stereoscopic-heating electronic cigarette according to claim 1, wherein the heat-controlling member comprises a heat-controlling casing and a power source within the heat-controlling casing;
a Universal Serial Bus (USB) interface is set at the bottom of the heat-controlling casing, a battery short-circuit contactor, which is matching with the short-circuit contactor, is set on the upper part of the heat-controlling casing; a Printed Circuit Board Assembly (PCBA) controlling board and a plurality of controlling buttons corresponding to the PCBA controlling board are set on the upper part of the power source.

4. The annular stereoscopic-heating electronic cigarette according to claim 3, wherein the openwork member is a hollowed cylinder with a plurality of holes set on its circumferential surface, or the openwork member is an inner container supporter assembled by a plurality of brackets;
wherein the hollowed cylinder or the inner container supporter is made of aluminum.

5. The annular stereoscopic-heating electronic cigarette according to claim 4, the shape of the smoke-controlling button is a triangle; a plurality of bumps, which act as a protection and are designed according to human engineering, are evenly set on the surface of the smoke-controlling button; a plurality of recesses, which act as a protection and are designed according to human engineering, are set on the surface of the annular stereoscopic-heating casing and heat-controlling casing.

6. The annular stereoscopic-heating electronic cigarette according to claim 2, wherein the heat-controlling member comprises a heat-controlling casing and a power source within the heat-controlling casing;
a Universal Serial Bus (USB) interface is set at the bottom of the heat-controlling casing; a battery short-circuit contactor, which is matching with the short-circuit contactor, is set on the upper part of the heat-controlling casing; a Printed Circuit Board Assembly (PCBA) controlling board and a plurality of controlling buttons corresponding to the PCBA controlling board are set on the upper part of the power source
